(19) United States
(12) Patent Application Publication
(10) Pub. No.: US 2026/0272211 A1
(43) Pub. Date: Sep. 17, 2026

(54) BREWING AND COOLING A BEVERAGE

(71) Applicant: ColdSnap, Corp., Billerica, MA (US)

(72) Inventors: Benjamin Fichera, Newburyport, MA (US); David Dussault, Stoneham, MA (US)

(21) Appl. No.: 19/465,668

(22) Filed: Jan. 30, 2026

Related U.S. Application Data
(60) Provisional application No. 63/751,815, filed on Jan. 30, 2025.

(51) Int. Cl. A47J 31/46; A47J 31/36; A47J 31/54; F24H 1/10; F25B 1/00; F25B 39/00; F25B 39/02; F25B 41/37

(52) U.S. Cl. CPC A47J 31/469; A47J 31/3676; A47J 31/542; F24H 1/102; F25B 1/00; F25B 39/00; F25B 41/37; F25B 39/02

(57) ABSTRACT

Some machines for brewing and then cooling a single serving of a beverage include a housing and a receptacle configured to receive a pod containing ingredients for producing the single serving of beverage. The machines include an economizer having a plurality of flow channels configured to transfer heat from the beverage to water as the beverage and the water flow through respective channels in opposite directions to assist in heating the water and cooling the beverage. The machines include an evaporator having a plurality of flow channels configured to transfer heat from (i) the beverage after being at least partially cooled by the economizer (ii) to a refrigerant as the beverage and the refrigerant flow through respective channels in the same direction or opposite directions to further cool the beverage. The machines include a dispenser configured to dispense the cooled beverage from the machine after the beverage has been cooled by the economizer and the evaporator.

### CLAIM OF PRIORITY

This application claims priority under 35 USC § 119(e) to U.S. Patent Application Ser. No. 63/751,815, filed on Jan. 30, 2025, the entire contents of which are hereby incorporated by reference.

### TECHNICAL FIELD

This specification relates generally to systems for brewing and cooling a beverage, and more particularly to systems for brewing hot coffee and then chilling the hot coffee.

### BACKGROUND

Some machines can brew hot beverages (e.g., coffee) and dispense the hot beverage into a cup or container. Chilling the hot beverage to produce, e.g., iced coffee, is often cumbersome and time consuming. For example, a user can store a cup or container of the hot beverage in a refrigerator to allow the hot beverage to cool but this often requires the user to wait for long periods of time (e.g., >10 minutes). Ice cubes can also be used to speed up chilling of the beverage but melted ice cubes would dilute the beverage.

### SUMMARY

This specification describes systems and methods for brewing and then cooling a single serving of a hot beverage to form a chilled beverage in a short amount of time (e.g., within 3 minutes) within the electrical constraints of a kitchen appliance (e.g., using no more than 1500 W at 120V/60 Hz). For example, a countertop machine receives a coffee pod, brews the hot coffee from the coffee pod, rapidly cools the hot coffee, and then dispenses the chilled coffee into a cup or container for consumption. In some examples, this is achieved using an economizer and an evaporator in tandem.

Some machines for brewing and then cooling a single serving of a beverage (e.g., coffee, tea, etc.) include a housing and a receptacle configured to receive a pod containing ingredients for producing the single serving of the beverage. Some machines include an economizer including a plurality of flow channels configured to transfer heat from the produced beverage to water as the beverage and the water flow through respective channels in opposite directions to assist in heating the water and cooling the beverage. Some machines include a water heater configured to further heat the water after the water has passed through the economizer and a brewing system configured to flow the heated water through the pod in the receptacle for brewing the beverage from the ingredients within the pod.

Some machines include an evaporator including a plurality of flow channels configured to transfer heat from (i) the produced beverage after being at least partially cooled by the economizer to (ii) a refrigerant as the beverage and the refrigerant flow through respective channels in the same direction or opposite directions to further cool the beverage. Some machines include a refrigeration system defining a closed fluid loop for the refrigerant such that the refrigerant flows from a compressor, through a condenser, through an expansion device, through the evaporator, and back to the compressor. Some machines include a dispenser configured to dispense the cooled beverage from the machine after the beverage has been cooled by the economizer and the evaporator.

Some machines include one or more of the following features.

In some embodiments, the plurality of flow channels of the economizer and the plurality of flow channels of the economizer are hexagonal.

In some embodiments, the plurality of flow channels of the economizer and the plurality of flow channels of the evaporator are hexagonal, square, circular, oval, octagonal, triangular, truncated diamond, or another polygon that nests tightly (e.g., to define a close-packed periodic arrangement).

In some embodiments, the machine is configured to brew approximately 12 fluid oz. of hot coffee to a temperature of approximately 180° F.

In some embodiments, the machine is configured to chill approximately 12 fluid oz. of hot coffee to a temperature between 32° F. and 65° F. within 30 seconds to 3 minutes. In some cases, the machine is configured to chill approximately 12 fluid oz. of hot coffee to a temperature of approximately 40° F. within 30 seconds to 3 minutes.

In some embodiments, the machine is configured to continuously brew, cool, and dispense the beverage such that the beverage is dispensed from the machine while the machine is still brewing the beverage.

In some embodiments, the machine is configured to provide multiple single servings of the beverage back-to-back from one another.

In some embodiments, the machine is a countertop-sized appliance that is configured to operate using a power source of 115V/60 Hz. In some cases, the machine is total input power constrained to 1500 W for 115V-15 A plug operation.

In some embodiments, the pod is a Keurig® K-Cup® containing ingredients for producing coffee.

In some embodiments, the pod is a coffee pod, and the beverage is coffee.

In some embodiments, the plurality of flow channels of the economizer and the plurality of flow channels of the economizer define alternating microchannels in a periodic close packed arrangement.

In some embodiments, the water heater is a flow-through electrical resistance heater for heating water as the water passes through the water heater.

In some embodiments, each channel of the plurality of flow channels of the evaporator and the plurality of flow channels of the evaporator have a width defining a flow size of between 0.02 inches to 0.12 inches. In some cases, the width is approximately 0.04 inches.

In some embodiments, the evaporator is configured to operate at temperatures between −40° F. and +30° F. In some cases, the evaporator is configured to operate at approximately +20° F.

In some embodiments, a surface area of the plurality of flow channels of the economizer is between 0.1 and 1.5 ft². In some cases, the surface area of the plurality of flow channels of the economizer is approximately 0.4 ft².

In some embodiments, a surface area of the plurality of flow channels of the evaporator is between 0.05 and 1.0 ft². In some cases, the surface area of the plurality of flow channels of the evaporator is approximately 0.2 ft².

In some embodiments, the compressor of the refrigeration system has a displacement between 2 and 20 cc (cm³). In some cases, the displacement is approximately 5 cc.

In some embodiments, the economizer and the evaporator are substantially identical.

In some embodiments, the economizer and the evaporator are substantially identical except have a different number of flow channels and/or differently-sized flow channels.

In some embodiments, the economizer includes end caps disposed on each end of the aluminum body for sealing the flow channels.

In some embodiments, the evaporator is configured such that the beverage and the refrigerant flow through the respective flow channels of the evaporator in the same direction to further cool the beverage. In some examples, flowing the refrigerant and the beverage in the same direction reduces ice crystal formation within the evaporator.

In some embodiments, overall dimensions of the economizer are approximately 3 in×3 in×4 in.

In some embodiments, overall dimensions of the evaporator are approximately 3 in×3 in×2 in.

In some embodiments, the expansion device is a capillary tube heat exchanger.

In some embodiments, the expansion device is a capillary tube arranged as part of a heat exchanger.

Some machines for brewing and then cooling a single serving of coffee include a housing and a receptacle configured to receive a coffee pod containing ingredients for producing the single serving of coffee. The machine includes an economizer that includes: an aluminum body; a plurality of first channels extending through the aluminum body in a first direction; a plurality of second channels extending through the aluminum body and parallel to the plurality of first channels, the plurality of second channels being disposed between the plurality of first channels; a plurality of third channels extending through the aluminum body in a second direction perpendicular to the first direction, the third channels being in fluid communication with a fraction of the first channels; and a plurality of fourth channels extending through the aluminum body in the second direction, the fourth channels being in fluid communication with a fraction of the second channels.

The economizer includes a first inlet manifold including a first inlet channel and a plurality of first outlet channels, the first outlet channels being in fluid communication with the plurality of fourth channels for distributing water from the first inlet channel to the plurality of fourth channels which distribute water to the plurality of the second channels; and a first outlet manifold including a first outlet channel and a plurality of first inlet channels, the first inlet channels being in fluid communication with the plurality of fourth channels for combining the water from the plurality of second channels and allowing the water to exit the first outlet manifold at the first outlet channel.

The economizer includes a second inlet manifold including a second inlet channel and a plurality of second outlet channels, the second outlet channels being in fluid communication with the plurality of third channels for distributing coffee from the second inlet channel to the plurality of third channels which distribute the coffee to the plurality of first channels; and a second outlet manifold including a second outlet channel and a plurality of second inlet channels, the second inlet channels being in fluid communication with the plurality of third channels for combining coffee from the plurality of first channels and allowing the coffee to exit the second outlet manifold at the second outlet channel.

The economizer is configured such that thermal energy is transferred from the coffee to the water as the coffee and the water flow through the respective channels of the economizer in opposite directions to assist in heating the water (e.g., pre-heating the water) and cooling the coffee (e.g., pre-cooling the coffee).

The machine includes a water heater configured to further heat the water after the water has passed through the economizer and has been pre-heated by the economizer, and a brewing system configured to flow the heated water through the coffee pod in the receptacle for brewing coffee from the ingredients within the coffee pod.

The machine includes an evaporator that includes an aluminum body; a plurality of first channels extending through the aluminum body in a first direction; a plurality of second channels extending through the aluminum body and parallel to the plurality of first channels, the plurality of second channels being disposed between the plurality of first channels; a plurality of third channels extending through the aluminum body in a second direction perpendicular to the first direction, the third channels being in fluid communication with the first channels; and a plurality of fourth channels extending through the aluminum body in the second direction, the fourth channels being in fluid communication with the second channels.

The evaporator includes a first inlet manifold including a first inlet channel and a plurality of first outlet channels, the first outlet channels being in fluid communication with the plurality of fourth channels for distributing coffee from the first inlet channel to the plurality of fourth channels which distribute coffee to the plurality of second channels, the first inlet manifold of the evaporator being in fluid communication with the first outlet manifold of the economizer for allowing coffee to flow from the economizer to the evaporator; and a first outlet manifold including a first outlet channel and a plurality of first inlet channels, the first inlet channels being in fluid communication with the plurality of fourth channels for combining the coffee from the plurality of second channels and allowing the coffee to exit the first outlet manifold at the first outlet channel.

The evaporator includes a second inlet manifold including a second inlet channel and a plurality of second outlet channels, the second outlet channels being in fluid communication with the plurality of third channels for distributing a refrigerant from the second inlet channel to the plurality of third channels which distribute the refrigerant to the plurality of first channels; and a second outlet manifold including a second outlet channel and a plurality of second inlet channels, the second inlet channels being in fluid communication with the plurality of third channels for combining the refrigerant from the plurality of first channels and allowing the refrigerant to exit the second outlet manifold at the second outlet channel.

The evaporator is configured such that thermal energy is transferred from the coffee to the refrigerant as the coffee and the refrigerant flow through the respective channels of the evaporator in the same direction or opposite directions to further cool the coffee after the economizer has partially cooled the coffee.

The machine includes a refrigeration system defining a closed fluid loop for the refrigerant such that the refrigerant flows from a compressor, through a condenser, through an expansion device, through the evaporator, and back to the compressor; and a dispenser configured to dispense the cooled coffee from the machine after the coffee has been cooled by the economizer and the evaporator.

The systems and method described in this application have one or more of the following advantages.

The economizer reduces the overall power consumption of the machine while still allowing the chilled beverage to be produced quickly (e.g., within 3 minutes). This is helpful in non-commercial (e.g., household) settings where the machine is powered by 15 A outlets. For example, small alternating microchannels in the economizer and the evaporator increase performance and lower power consumption. The economizer pre-cools hot coffee and pre-heats cold water.

Having the economizer configured such that hot coffee flows in one direction while water flows in the other direction (e.g., so called “counter-flow”) allows for efficient heat transfer between the water and the coffee. And having the evaporator configured such that coffee and refrigerant flow in the same direction helps to reduce ice formation on the inside of the coffee flow channels of the evaporator.

By using an economizer and evaporator in tandem, the disclosed systems allow back-to-back production of cold coffee without a degradation in performance because (i) there is no increase in temperature of each sequentially dispensed cup of cold coffee and (ii) the system requires minimal time to recharge between the cups of coffee, even if 5, 10, 15, or more cups are dispensed in a row. In some examples, the machine 100 dispenses a continuous stream of the beverage without an increase in temperature of the dispensed chilled beverage. Thus, a user does not need to wait hours between dispensed cups of the beverage to allow time for the system to recharge.

The systems brew 12 fl. oz. of hot coffee to approximately 180° F., chill 12 fl. oz. of coffee in 30 seconds to 3 minutes to 32° F.-65° F. degrees, and preferably 40° F. The systems use continuous cooling from the brewing process to allow brewing and chilling to happen in parallel. The systems allow for back-to-back beverages to be produced and use 115V/60 Hz operation. The systems are implemented in a countertop-sized appliance and can use off-the-shelf Keurig® K-cups®.

For ease of description, terms such as “upward”, “downward” “left” and “right” are relative to the orientation of system components in the figures rather than implying an absolute direction.

The details of one or more embodiments of these systems and methods are set forth in the accompanying drawings and the description below. Other features, objects, and advantages of these systems and methods will be apparent from the description and drawings, and from the claims.

### DESCRIPTION OF FIGURES

FIG. 1 is a perspective view of a machine for brewing and cooling a beverage (e.g., coffee, tea, etc.).

FIGS. 2A and 2B are schematics of a brewing and cooling system of the machine of FIG. 1 when configured to serve a chilled beverage.

FIGS. 3A and 3B are schematics of the brewing and cooling system of the machine of FIG. 1 when configured to serve a hot beverage.

FIG. 4 is a schematic of the brewing and cooling system of the machine of FIG. 1.

FIG. 5A is a translucent perspective view of a heat exchanger for the machine of FIG. 1. FIG. 5B is non-translucent perspective view of the heat exchanger of FIG. 5A. FIGS. 5C-5E are cross-sectional views of the heat exchanger of FIGS. 5A and 5B.

FIG. 6A is a perspective view of the heat exchanger of FIGS. 5A-5E configured as an economizer. FIG. 6B is a perspective view of the heat exchanger of FIGS. 5A-5E configured as an evaporator.

FIG. 7 is an exploded view of an alternate heat exchanger for the machine of FIG. 1.

FIGS. 8A and 8B are perspective views of an alternate evaporator for the machine of FIG. 1.

Like reference symbols in the various drawings indicate like elements.

### DETAILED DESCRIPTION

This specification describes systems and methods for brewing and then cooling a single serving of a hot beverage to form a chilled beverage in a short amount of time (e.g., within 3 minutes) within the electrical constraints of a kitchen appliance (e.g., using no more than 1500 W at 120V/60 Hz). For example, a countertop machine receives a coffee pod (e.g., by a user placing the coffee pod in the machine), brews the hot coffee from the coffee pod, rapidly cools the hot coffee to produce chilled coffee, and then dispenses the chilled coffee into a cup or container for consumption. In some examples, this is achieved using an economizer and an evaporator in tandem.

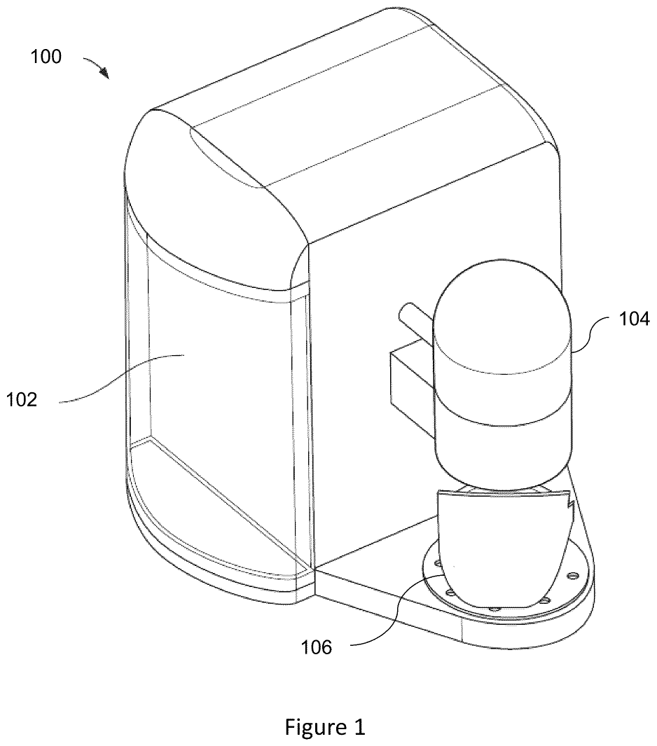

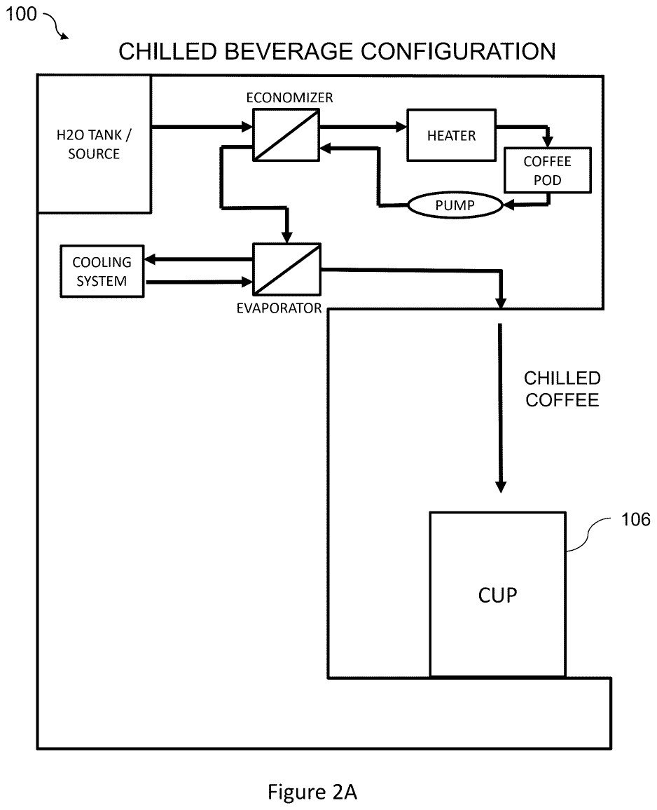

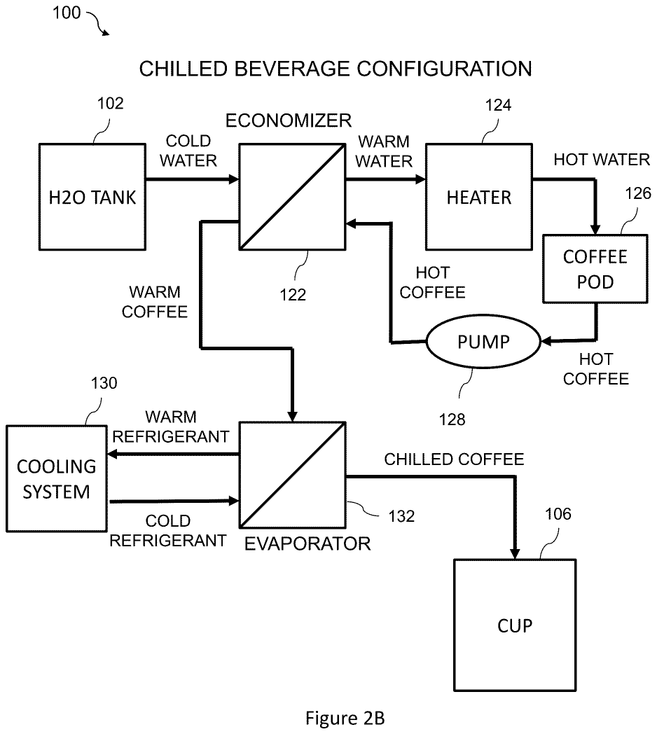

FIG. 1 is a perspective view of a machine 100 for brewing and cooling a beverage (e.g., coffee, tea, etc.). The machine 100 includes a housing, a water source 102 (e.g., a water tank or a plumbed-in water supply), a receptacle 104 for receiving a pod (e.g., coffee pod 126—see FIG. 2B) containing ingredients for producing the beverage, and a dispensing area for a container 106 (e.g., a platform for a cup 106).

FIGS. 2A and 2B are schematics of a brewing and cooling system of the machine 100. In the configuration shown in FIGS. 2A and 2B, the brewing and cooling system is configured to serve a chilled beverage. Referring to FIG. 2B, the brewing and cooling system includes a water tank 102, an economizer 122, a water heater 124, a receptacle sized to receive pod 126, a pump 128, a cooling system 130, and an evaporator 132. In some examples, the receptacle is located under a lid of the machine 100, and a user opens the lid to expose the receptacle and insert the pod 126 into the receptacle. In some examples, the pod 126 is a Keurig® K-Cup® containing ground coffee ingredients.

In the configuration shown in FIGS. 2A and 2B, cold water (e.g., room temperature water) flows from the water tank 102, through a plurality of first flow channels of the economizer 122 to increase the temperature of the water (e.g., pre-heat the water), through the water heater 124 to further increase the temperature of the water such that the water is now sufficiently hot for brewing the beverage (e.g., approximately 180° F.-200° F.). In some examples, the water heater 124 is a flow-through electrical resistance heater configured to heat the water as the water passes through the water heater 124.

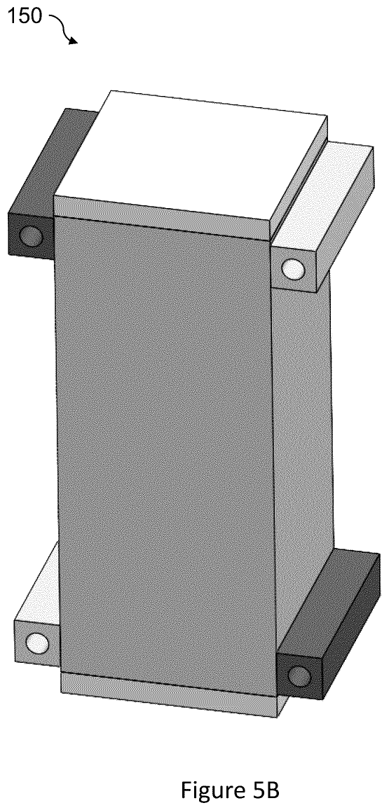

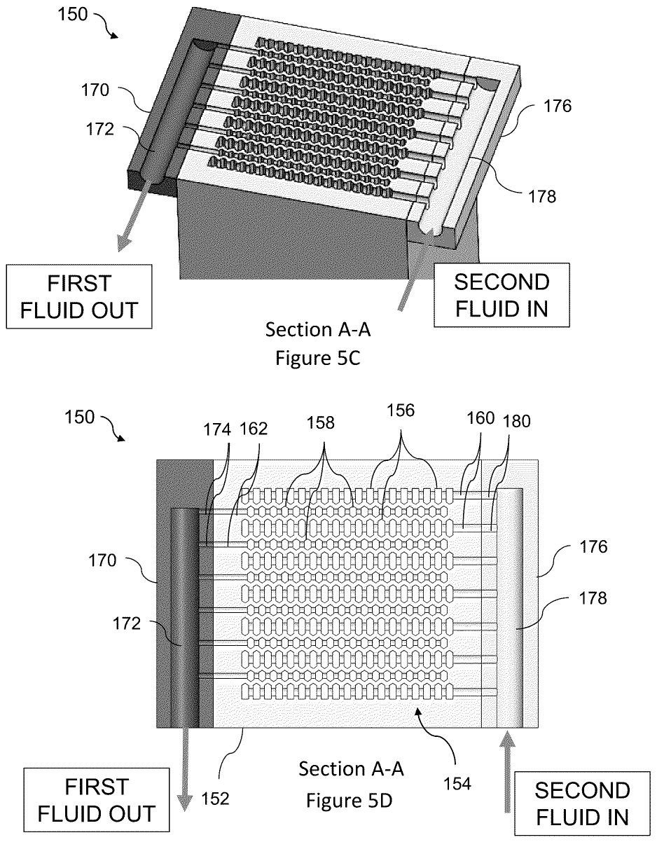

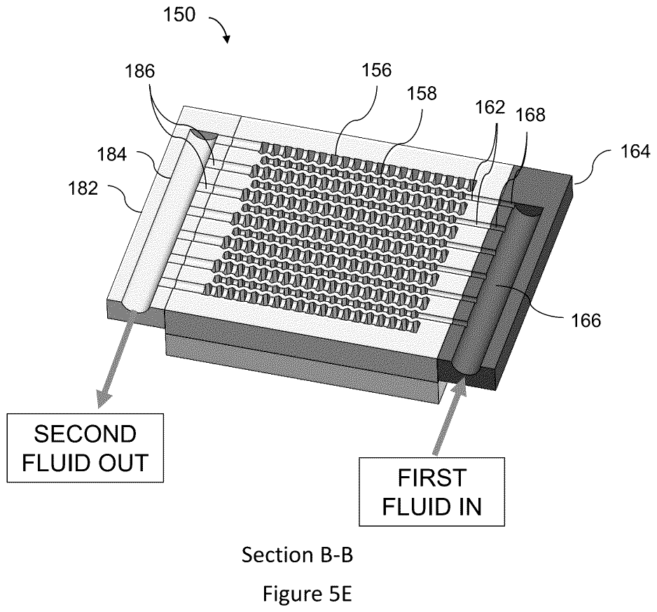

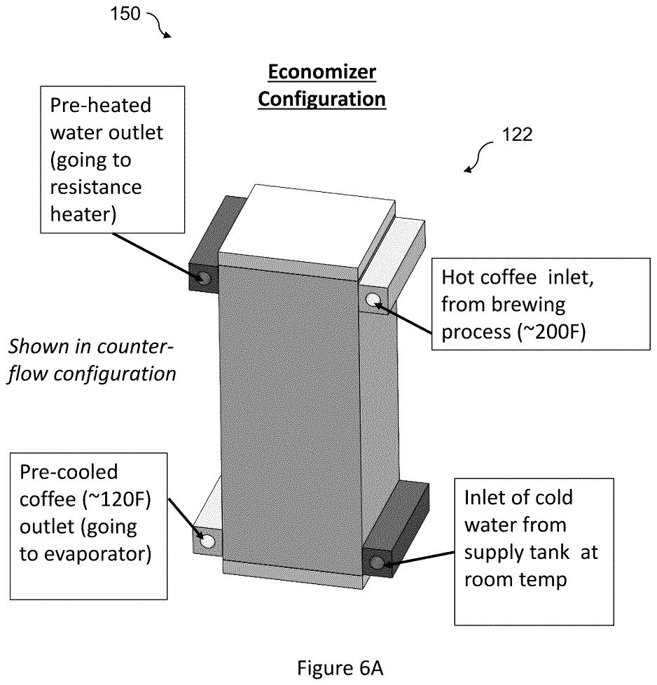

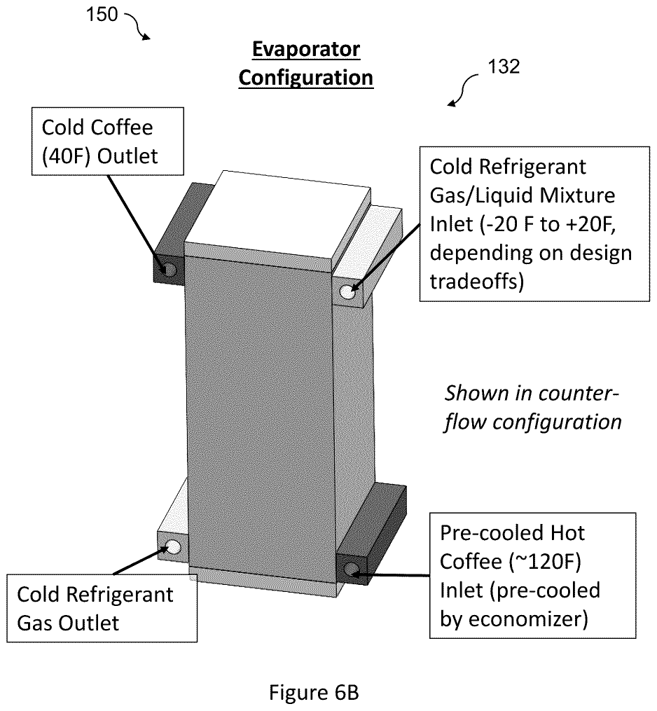

The machine 100 includes a brewing system configured to flow the heated water through the pod 126 in the receptacle for brewing the beverage from the ingredients within the pod 126. Once brewed, the hot beverage then flows through a pump 128 and then through a plurality of second flow channels of the economizer 122 to reduce a temperature of the beverage (e.g., to pre-cool the beverage). The first and second flow channels of the economizer 122 are in thermal contact with one another to allow thermal energy to be exchanged between the first and second flow channels. Further details of the economizer 122 are described with reference to FIGS. 5A-5E and 6A below.

By flowing cold water and the hot beverage through the economizer 122 at the same time, heat is transferred from the hot beverage to the cold water to (i) at least partially cool the hot beverage before the beverage is cooled by the cooling system 130 (e.g., pre-cooling), and (ii) at least partially warm the water before the water is heated by the water heater 124 (e.g., pre-heating). This process effectively reduces the necessary power consumption of the water heater 124 and the cooling system 130. In some examples, the beverage exiting the economizer 122 is at a temperature of approximately 120° F. In some examples, the economizer 122 is configured to reduce the temperature of the beverage by approximately 80° F. The economizer 122 assists in heating the water and cooling the beverage.

Once the beverage exits the economizer 122, the beverage flows to the evaporator 132. In some examples, the economizer 122 and the evaporator 132 are physically spaced apart from one another. In some examples, the economizer 122 and the evaporator 132 are attached to one another. In either case, the economizer 122 and the evaporator 132 are in fluid communication with one another to allow the beverage to flow from an outlet of the economizer 122 to an inlet of the evaporator 132.

In some examples, the beverage has a temperature of approximately 120° F. when flowing into the evaporator 132. As the beverage flows through a plurality of first channels of the evaporator 132, the beverage is chilled to approximately 40° F. Then the chilled beverage having a temperature of 40° F. is dispensed from the machine into the cup 106. Cooling the beverage within the evaporator 132 is achieved by flowing a refrigerant (e.g., a two-phase refrigerant) through a plurality of second channels of the evaporator 132. In some examples, the refrigerant flows through the evaporator 132 in the same direction as the beverage to reduce the chances of ice crystals forming within the evaporator 132. However, in other examples, the refrigerant flows through the evaporator 132 in an opposite direction as the beverage. The plurality of flow channels of the evaporator 132 are configured to transfer heat from (i) the beverage after being at least partially cooled by the economizer 122 (ii) to the refrigerant as the beverage and the refrigerant flow through respective channels in the same direction or opposite directions to further cool the beverage and produce the chilled beverage for dispensing. Further details of the evaporator 132 are described with reference to FIGS. 5A-5E and 6B below.

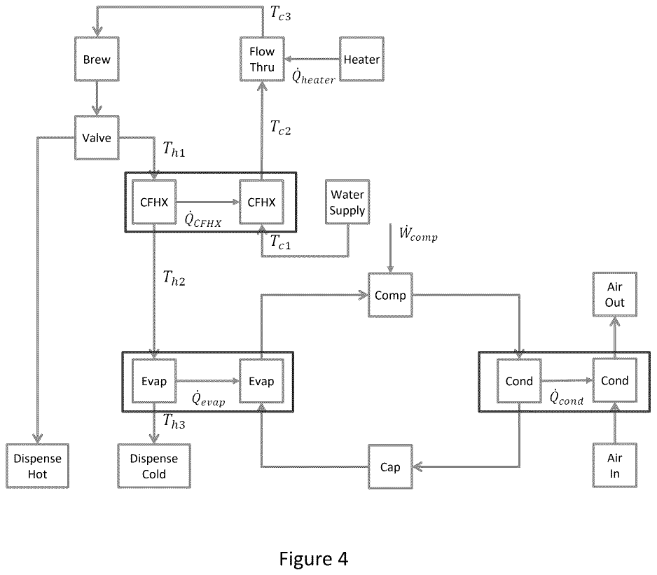

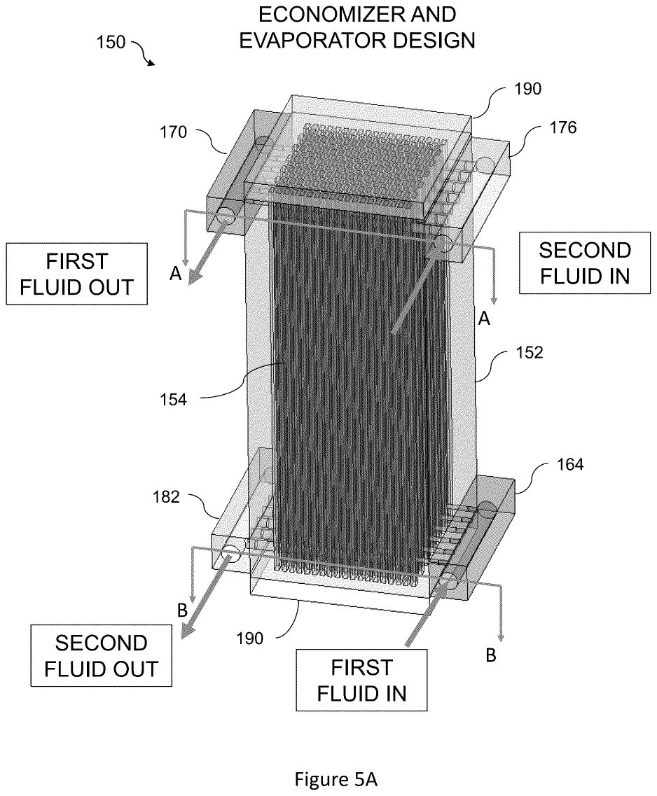

The cooling system 130 circulates the refrigerant through the evaporator 132 for cooling the beverage. In some examples, the cooling system 130 includes a refrigeration system defining a closed fluid loop for the refrigerant such that the refrigerant flows from a compressor, through a condenser, through an expansion device, through the evaporator 132, and back to the compressor (see FIG. 4). In some examples, the expansion device is a capillary tube heat exchanger. In some examples, the expansion device is a capillary tube arranged as part of a heat exchanger. In some examples, the compressor of the refrigeration system has a displacement between 2 and 20 cc. In some cases, the displacement is approximately 5 cc.

The cooling system 130 provides cold refrigerant to the evaporator 132 and receives warm refrigerant from the evaporator 132. The refrigerant warms in the evaporator 132 as heat is transferred from the beverage to the refrigerant. In some examples, the refrigerant enters the evaporator 132 in a liquid-phase, superheats within the evaporator 132, and exits the evaporator 132 in a gas-phase. In some examples, the evaporator 132 operates at temperatures between −40° F. and +30° F. In some examples, the evaporator 132 operates at approximately +20° F.

The dispenser is configured to dispense the cooled (or chilled) beverage from the machine 100 after the beverage has been cooled by the economizer 122 and the evaporator 132. For example, the chilled beverage is dispensed from the machine 100 into a cup 106.

In some examples, the machine 100 brews approximately 12 fluid oz. of hot coffee to a temperature of approximately 180° F. In some examples, the machine 100 chills approximately 12 fluid oz. of hot coffee to a temperature between 32° F. and 65° F. within 30 seconds to 3 minutes. In some examples, the machine 100 chills approximately 12 fluid oz. of hot coffee to approximately 40° F.

In some examples, the machine 100 continuously brews, cools, and dispenses the beverage such that a first quantity of a beverage is dispensed from the machine 100 while a second quantity of the beverage is being brewed by the machine 100. In some examples, the machine 100 provides multiple single servings of the beverage back-to-back from one another. For example, the machine 100 not only allows back-to-back production of cold coffee, but also allows back-to-back production without a degradation in performance because (i) there is no increase in temperature of each sequentially dispensed cup of cold coffee and (ii) requires minimal time to recharge between cups, even if 5, 10, or 15 cups are dispensed in a row. In some examples, the machine 100 dispenses a continuous stream of the beverage.

In some examples, the machine 100 is a countertop-sized appliance configured to operate using a power source of 115V/60 Hz. In some cases, the machine 100 is total input power constrained to 1500 W for 115V-15 A plug operation.

In some examples, the machine 100 is configured to pump hot water through the economizer 122 and the evaporator 132 for cleaning. In some examples, the machine 100 pumps (e.g., by the pump 128) water through all fluid lines to clean all internal surfaces of the economizer 122 and the evaporator 132 that have contacted the beverage. The machine 100 then discharges the dirty water into a cup 106 for disposal.

However, in other examples, the machine 100 instead routes the dirty water to an outlet on the rear of the housing which can be connected to a drain line. Such a configuration allows the machine to automatically and periodically clean itself without user intervention.

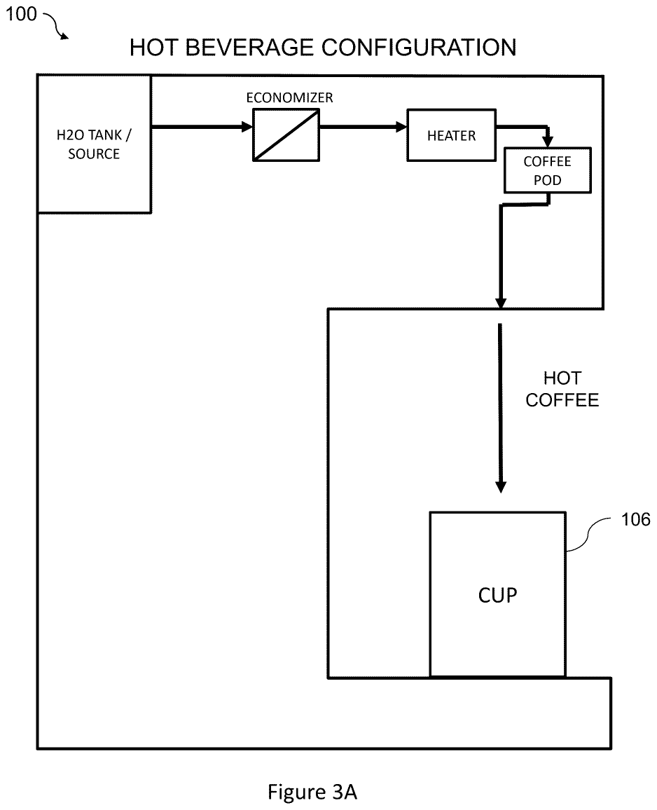

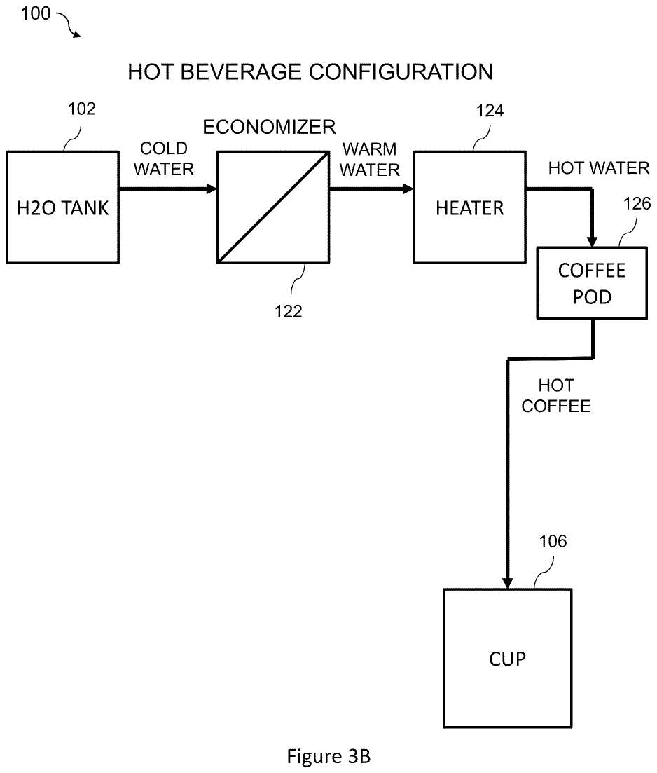

FIGS. 3A and 3B are schematics of the brewing and cooling system of the machine of FIG. 1 when configured to serve a hot beverage. The configuration shown in FIGS. 3A and 3B is substantially similar to the configuration shown in FIGS. 2A and 2B except the hot beverage is not cooled and instead is discharged directly into the cup 106. In some examples, the machine includes a valve (see FIG. 4) for diverting the hot beverage directly into the cup 106 instead of allowing the hot beverage to be cooled by the economizer 122 and the evaporator 132. Using a valve allows a single machine 100 to provide both hot and cold beverages.

FIG. 4 is an additional schematic of the brewing and cooling system of the machine 100. The term “CFHX” stands for counterflow heat exchanger and represents the economizer 122.

FIGS. 5A-5E are views of a heat exchanger 150 for machine 100. FIG. 5A is a translucent perspective view, FIG. 5B is non-translucent perspective view, and FIGS. 5C-5E are cross-sectional views. In some examples, the heat exchanger 150 is the economizer 122 and the evaporator 132. For example, in some machines, the economizer 122 and the evaporator 132 are configured as the heat exchanger 150. In some machines, the economizer 122 and the evaporator 132 are substantially identical, while in other machines, the economizer 122 and the evaporator 132 are different. In some machines, the economizer 122 and the evaporator 132 are substantially identical except have a different number of flow channels and/or differently-sized flow channels.

The heat exchanger 150 includes an aluminum body 152 defining a plurality of flow channels 154 that include a plurality of first channels 156 extending through the aluminum body 152 in a first direction (e.g., an extruded direction of the aluminum body 152, an axial direction of the aluminum body 152, or a vertical direction). Each heat exchanger 150 includes one aluminum body 152. While the aluminum body 152 is formed of aluminum, other materials can also be used. For example, in some bodies are formed of copper, steel, or any other metal. In some cases, an aluminum alloy is used.

The plurality of flow channels 154 include a plurality of second channels 158 extending through the aluminum body 152 and parallel to the plurality of first channels 156. The plurality of second channels 158 being disposed between the plurality of first channels 156.

The plurality of first and second channels 156, 158 are arranged in a periodic array of hexagonally-shaped pathways to maximize the heat transfer between a first fluid flowing through the plurality of first channels 156 and a second fluid flowing through the plurality of second channels 158. However, some heat exchangers include other shaped pathways. For example, some heat exchangers include square, circular, oval, octagonal, triangular, truncated diamond, and/or another polygon that nests tightly. In some examples, the plurality of flow channels 154 define alternating microchannels that pass through the aluminum body 152 (e.g., completely through the aluminum body 152 or partially through the aluminum body 152).

In the example shown, the heat exchanger 150 includes a grid of 19×7 first channels 156, and a grid of 18×6 second channels 158. However, other heat exchangers include different numbers of channels. Typically, the size, shape, and arrangement of the flow channels are designed to strike a balance between maximizing heat transfer and minimizing pressure loss of the fluid.

The plurality of flow channels 154 include a plurality of third channels 160 extending through the aluminum body 152 in a second direction perpendicular to the first direction. Each third channel 160 is in fluid communication with a fraction or portion of the first channels 156. In the example shown, the second direction extends horizontally such that the third channels 160 and the first channels 156 intersect one another at a 90° angle. The plurality of flow channels 154 include a plurality of fourth channels 162 extending through the aluminum body 152 in the second direction from an opposite side of the aluminum body 152 as the plurality of third channels 160. Each fourth channel 162 is in fluid communication with a fraction or portion of the second channels 158. In some examples, the plurality of third and fourth channels 160, 162 are cross-drilled into the aluminum body 152 from opposite sides of the aluminum body 152.

The heat exchanger 150 includes a first inlet manifold (or header) 164 having a first inlet channel 166 and a plurality of first outlet channels 168. The first outlet channels 168 are in fluid communication with the plurality of fourth channels 162 for (i) distributing water (when configured as the economizer 122) from the first inlet channel 166 to the plurality of fourth channels 162 which distribute the water to the plurality of second channels 158, or (ii) distributing the hot beverage (when configured as the evaporator 132) from the first inlet channel 166 to the plurality of fourth channels 162 which distribute the hot beverage to the plurality of second channels 158.

The heat exchanger 150 includes a first outlet manifold 170 having a first outlet channel 172 and a plurality of first inlet channels 174. The first inlet channels 174 are in fluid communication with the plurality of fourth channels 162 for (i) combining the water from the plurality of second channels 158 and allowing the water to exit the first outlet manifold 170 at the first outlet channel 172 (when configured as the economizer 122), or combining the cooled beverage from the plurality of second channels 158 and allowing the cooled beverage to exit the first outlet manifold 170 at the first outlet channel 172 (when configured as the evaporator 132).

The heat exchanger 150 includes a second inlet manifold 176 having a second inlet channel 178 and a plurality of second outlet channels 180. The second outlet channels 180 are fluid communication with the plurality of third channels 160 for (i) distributing the hot beverage from the second inlet channel 178 to the plurality of third channels 160 which distribute the hot beverage to the plurality of first channels 156 (when configured as the economizer 122), or (ii) distributing the refrigerant from the second inlet channel 178 to the plurality of third channels 160 which distribute the refrigerant to the plurality of first channels 156 (when configured as the evaporator 132).

The heat exchanger 150 includes a second outlet manifold 182 having a second outlet channel 184 and a plurality of second inlet channels 186. The second inlet channels 186 are in fluid communication with the plurality of third channels 160 for (i) combining the pre-cooled beverage from the plurality of first channels 156 and allowing the pre-cooled beverage to exit the second outlet manifold 182 at the second outlet channel 184 (when configured as the economizer 122), or combining the warm refrigerant from the plurality of first channels 156 and allowing the warm refrigerant to exit the second outlet manifold 182 at the second outlet channel 184 (when configured as the evaporator 132).

Each heat exchanger 150 includes four manifolds (or headers). Two manifolds serving as inlets and two manifolds serving as outlets. The heat exchanger 150 also includes end caps 190 disposed on each longitudinal end of the aluminum body 152 for sealing the flow channels 154. Each heat exchanger 150 includes two end caps 190. In some examples, the manifolds 164, 170, 176, and 182 and the end caps 190 are joined to the aluminum body 152 by brazing to prevent communication between coffee and refrigerant passages, for example.

In some examples, the plurality of flow channels 154 have a width defining a flow size of between 0.02 inches to 0.12 inches. In some cases, the width is approximately 0.04 inches.

FIG. 6A is a perspective view of the heat exchanger of FIGS. 5A-5E configured as the economizer 122. In some examples, the economizer 122 is configured such that thermal energy is transferred from the coffee to the water as the coffee and the water flow through the respective channels of the economizer in opposite directions from one another to assist in heating the water (e.g., pre-heating the water) and cooling the coffee (e.g., pre-cooling the coffee). While the economizer 122 is shown in a counter-flow configuration, in some cases, the flow is directed in the same direction.

In some examples, a surface area of the plurality of flow channels 154 of the economizer 122 is between 0.1 and 1.5 ft². In some cases, the surface area of the plurality of flow channels of the economizer 122 is approximately 0.4 ft². In some examples, overall dimensions of the economizer 122 are approximately 3 in×3 in×4 in.

FIG. 6B is a perspective view of the heat exchanger of FIGS. 5A-5E configured as the evaporator 132. In some examples, the evaporator 132 is configured such that thermal energy is transferred from the coffee to the refrigerant as the coffee and the refrigerant flow through the respective channels of the evaporator in the same direction as one another or in opposite directions as one another to further cool the coffee after the economizer has partially cooled the coffee. While the evaporator 132 is shown in a counter-flow configuration, in some cases, the flow is directed in the same direction (e.g., to reduce ice crystals forming within the evaporator).

In some examples, a surface area of the plurality of flow channels 154 of the evaporator 132 is between 0.05 and 1.0 ft². In some cases, the surface area of the plurality of flow channels 154 of the evaporator 132 is approximately 0.2 ft². In some examples, overall dimensions of the evaporator 132 are approximately 3 in×3 in×2 in.

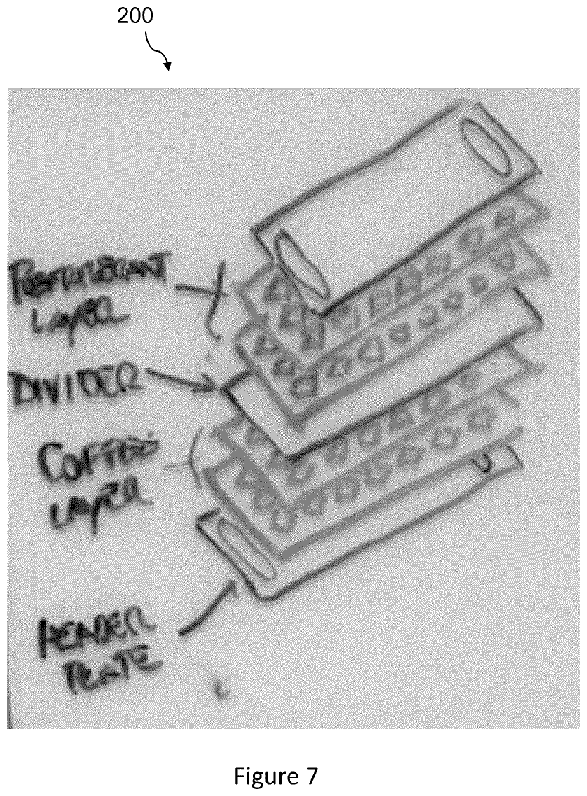

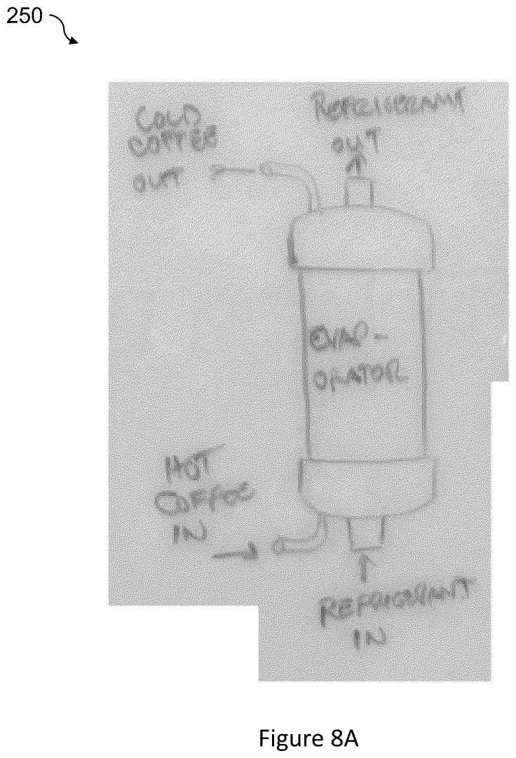

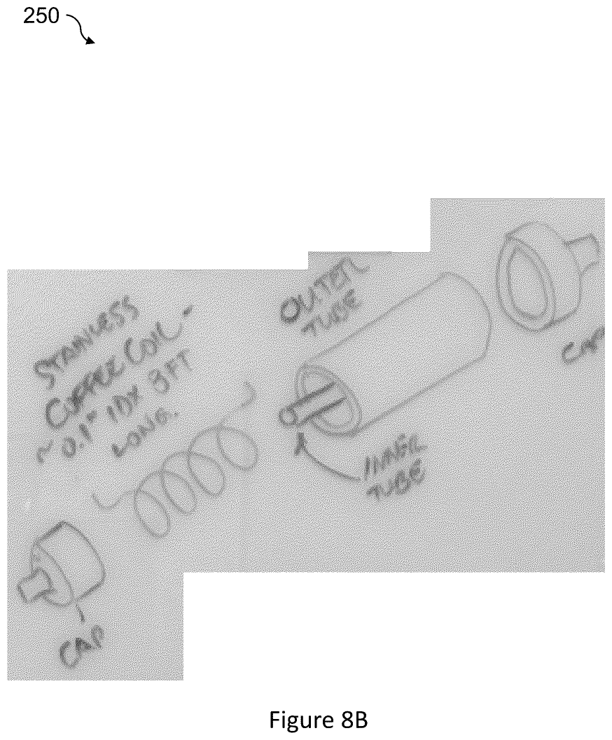

FIG. 7 is an exploded view of an alternate heat exchanger 200 for the machine 100. The heat exchanger 200 includes alternating layers of stamped sheet metal to reduce manufacturing complexity and cost. A divider is sandwiched between a refrigerant layer and a coffee layer (e.g., when configured as the evaporator 132) FIGS. 8A and 8B are perspective views of an alternate evaporator for the machine 100. The evaporator 250 includes a canister with a stainless steel coil inside the canister. Coffee flows in the bottom of the canister, through the coil, and out from the top of the canister. Refrigerant flows in the bottom of the canister, by the outside of the coil, and out from the top of the canister. In the configuration shown, the refrigerant and the coffee flow in the same direction (e.g., upwards). Although, as described above, in some examples, the refrigerant and the coffee flow in opposite directions relative to one another.

A number of systems and methods have been described. Nevertheless, it will be understood that various modifications may be made without departing from the spirit and scope of this disclosure. For example, although the heat exchangers have been generally illustrated as being in a vertical orientation during use, some machines have evaporators that are oriented horizontally or an angle to gravity during use. Accordingly, other embodiments are within the scope of the following claims.

1. A machine for brewing and then cooling a single serving of a beverage, the machine comprising:
a housing;
a receptacle configured to receive a pod containing ingredients for producing the single serving of the beverage;
an economizer comprising a plurality of flow channels configured to transfer heat from the produced beverage to water as the beverage and the water flow through respective channels in opposite directions to assist in heating the water and cooling the coffee;
a water heater configured to further heat the water after the water has passed through the economizer;
a brewing system configured to flow the heated water through the pod in the receptacle for brewing the beverage from the ingredients within the pod;
an evaporator comprising a plurality of flow channels configured to transfer heat from (i) the produced beverage after being at least partially cooled by the economizer to (ii) a refrigerant as the beverage and the refrigerant flow through respective channels in the same direction or opposite directions to further cool the beverage;
a refrigeration system defining a closed fluid loop for the refrigerant such that the refrigerant flows from a compressor, through a condenser, through an expansion device, through the evaporator, and back to the compressor; and
a dispenser configured to dispense the cooled beverage from the machine after the beverage has been cooled by the economizer and the evaporator.

2. The machine of claim 1, wherein the plurality of flow channels of the economizer and the plurality of flow channels of the evaporator are hexagonal.

3. The machine of claim 1, wherein the plurality of flow channels of the economizer and the plurality of flow channels of the evaporator are hexagonal, square, circular, oval, octagonal, triangular, truncated diamond, or another polygon that nests tightly.

4. The machine of claim 1, wherein the machine is configured to brew approximately 12 fluid oz. of hot coffee to a temperature of approximately 180° F.

5. The machine of claim 1, wherein the machine is configured to chill approximately 12 fluid oz. of hot coffee to a temperature between 32° F. and 65° F. within 30 seconds to 3 minutes.

6. (canceled)

7. The machine of claim 1, wherein the machine is configured to continuously brew, cool, and dispense the beverage such that beverage is dispensed from the machine while the beverage is still being brewed.

8. The machine of claim 1, wherein the machine is configured to provide multiple single servings of the beverage back-to-back from one another.

9. The machine of claim 1, wherein the machine is a countertop sized appliance that is configured to operate using a power source of 115V/60 Hz.

10. (canceled)

11. (canceled)

12. The machine of claim 1, wherein the plurality of flow channels of the economizer and the plurality of flow channels of the economizer define alternating microchannels.

13. The machine of claim 1, wherein the water heater is a flow through electrical resistance heater.

14. The machine of claim 1, wherein each channel of the plurality of flow channels of the evaporator and the plurality of flow channels of the economizer have a width defining a flow size of between 0.02 inches to 0.12 inches.

15. (canceled)

16. The machine of claim 1, wherein the evaporator is configured to operate at temperatures between −40° F. and +30° F.

17-21. (canceled)

22. The machine of claim 1, wherein the compressor of the refrigeration system has a displacement between 2 and 20 cc.

23. (canceled)

24. The machine of claim 1, wherein the economizer and the evaporator are substantially identical.

25. The machine of claim 1, wherein the economizer and the evaporator are substantially identical except have a different number of flow channels and/or the flow channels have different sizes.

26. The machine of claim 1, wherein the economizer comprises end caps disposed on each end of the aluminum body for sealing the flow channels and wherein the evaporator comprises end caps disposed on each end of the aluminum body for sealing the flow channels.

27. (canceled)

28. The machine of claim 1, wherein the evaporator is configured such that the beverage and the refrigerant flow through the respective flow channels of the evaporator in the same direction to further cool the beverage.

29. The machine of claim 1, wherein overall dimensions of the economizer are approximately 3 in×3 in×4 in and wherein overall dimensions of the evaporator are approximately 3 in×3 in×2 in.

30. (canceled)

31. The machine of claim 1, wherein the expansion device is a capillary tube heat exchanger.

32. (canceled)

33. A machine for brewing and then cooling a single serving of coffee, the machine comprising:
a housing;
a receptacle configured to receive a coffee pod containing ingredients for producing the single serving of coffee;
an economizer comprising:
an aluminum body;
a plurality of first channels extending through the aluminum body in a first direction;
a plurality of second channels extending through the aluminum body and parallel to the plurality of first channels, the plurality of second channels being disposed between the plurality of first channels;
a plurality of third channels extending through the aluminum body in a second direction perpendicular to the first direction, the third channels being in fluid communication with the first channels;
a plurality of fourth channels extending through the aluminum body in the second direction, the fourth channels being in fluid communication with the second channels;
a first inlet manifold comprising a first inlet channel and a plurality of first outlet channels, the first outlet channels being in fluid communication with the plurality of fourth channels for distributing water from the first inlet channel to the plurality of fourth channels which distribute the water to the plurality of second channels;
a first outlet manifold comprising a first outlet channel and a plurality of first inlet channels, the first inlet channels being in fluid communication with the plurality of fourth channels for combining the water from the plurality of second channels and allowing the water to exit the first outlet manifold at the first outlet channel;
a second inlet manifold comprising a second inlet channel and a plurality of second outlet channels, the second outlet channels being in fluid communication with the plurality of third channels for distributing coffee from the second inlet channel to the plurality of third channels which distribute the coffee to the plurality of first channels; and
a second outlet manifold comprising a second outlet channel and a plurality of second inlet channels, the second inlet channels being in fluid communication with the plurality of third channels for combining coffee from the plurality of first channels and allowing the coffee to exit the second outlet manifold at the second outlet channel,
wherein the economizer is configured such that thermal energy is transferred from the coffee to the water as the coffee and the water flow through the respective channels of the economizer in opposite directions to assist in heating the water and cooling the coffee;
a water heater configured to further heat the water after the water has passed through the economizer;
a brewing system configured to flow the heated water through the coffee pod in the receptacle for brewing coffee from the ingredients within the coffee pod;
an evaporator comprising:
an aluminum body;
a plurality of first channels extending through the aluminum body in a first direction;
a plurality of second channels extending through the aluminum body and parallel to the plurality of first channels, the plurality of second channels being disposed between the plurality of first channels;
a plurality of third channels extending through the aluminum body in a second direction perpendicular to the first direction, the third channels being in fluid communication with the first channels;
a plurality of fourth channels extending through the aluminum body in the second direction, the fourth channels being in fluid communication with the second channels;
a first inlet manifold comprising a first inlet channel and a plurality of first outlet channels, the first outlet channels being in fluid communication with the plurality of fourth channels for distributing coffee from the first inlet channel to the plurality of fourth channels which distribute the water to the plurality of second channels, the first inlet manifold of the evaporator being in fluid communication with the first outlet manifold of the economizer for allowing coffee to flow from the economizer to the evaporator;
a first outlet manifold comprising a first outlet channel and a plurality of first inlet channels, the first inlet channels being in fluid communication with the plurality of fourth channels for combining the coffee from the plurality of second channels and allowing the coffee to exit the first outlet manifold at the first outlet channel;
a second inlet manifold comprising a second inlet channel and a plurality of second outlet channels, the second outlet channels being in fluid communication with the plurality of third channels for distributing a refrigerant from the second inlet channel to the plurality of third channels which distribute the refrigerant to the plurality of first channels; and
a second outlet manifold comprising a second outlet channel and a plurality of second inlet channels, the second inlet channels being in fluid communication with the plurality of third channels for combining the refrigerant from the plurality of first channels and allowing the refrigerant to exit the second outlet manifold at the second outlet channel,
wherein the evaporator is configured such that thermal energy is transferred from the coffee to the refrigerant as the coffee and the refrigerant flow through the respective channels of the evaporator in the same direction or opposite directions to further cool the coffee after the economizer has partially cooled the coffee;
a refrigeration system defining a closed fluid loop for the refrigerant such that the refrigerant flows from a compressor, through a condenser, through an expansion device, through the evaporator, and back to the compressor; and
a dispenser configured to dispense the cooled coffee from the machine after the coffee has been cooled by the economizer and the evaporator.
